(19) United States
(12) Patent Application Publication
(10) Pub. No.: US 2017/0129648 A1
(43) Pub. Date: May 11, 2017

(54) STACKABLE WIPE CONTAINER AND METHOD OF MANUFACTURE THEREOF

(71) Applicant: Tessy Plastics Corporation, Elbridge, NY (US)

(72) Inventors: David Young, Syracuse, NY (US); Vincent Pilletteri, Shortsville, NY (US)

(21) Appl. No.: 15/343,646

(22) Filed: Nov. 4, 2016

Related U.S. Application Data
(60) Provisional application No. 62/251,473, filed on Nov. 5, 2015.

(51) Int. Cl. B65D 21/02; B29C 33/38; B65D 47/08; B65D 41/02; B65D 53/02

(52) U.S. Cl. CPC B65D 21/0233; B65D 41/023; B65D 53/02; B65D 47/08; B29C 33/38; B29L 2031/712

(57) ABSTRACT

A consumer product container for packaging a consumer product comprising a top portion, a bottom portion and an intermediate body portion disposed between and integral with, the top and bottom portions. The top portion includes an opening defining a lip having an internally-facing sealing surface configured to seal with a mating sealing surface of a closing cap. The bottom portion defines a base being substantially parallel to a plane which is normal to a longitudinal axis. The intermediate body portion circumscribes the longitudinal axis and defines an outwardly-directed draft angle relative to the longitudinal axis to facilitate stacking of multiple containers during shipment.

### BACKGROUND

The subject matter disclosed herein relates to storage and dispensing containers and a method of manufacture thereof, which containers may be used for such items as sanitary wipes, cleaning supplies, and other personal care products.

There are a variety of packaging, storage and dispensing containers designed to facilitate opening and closing of items intended to remain dry or wet depending upon the nature of the product. For example, some personal care products, such as sanitary wipes for infants, are soaked with a cleansing agent and must remain moist from the time the package is initially opened until the product is consumed. Other products, such as napkins for wiping down a wet surface must remain dry. These wipes, napkins or towels are typically stored in a container either in a continuous perforated roll or in a stacked/folded arrangement.

The storage containers of the type described above are typically blow-molded against a mold surface of a die which defines the outer mold line (OML) of the bottle or container. As such, bold-molding, controls the outer surface or OML dimensions of the container including an annular ring corresponding to the opening or lip of the container. This manufacturing process produces a soft, thin-walled, lip which maintains accurate OML dimensions, such that a cap having a similarly formed inner surface may close over and seal the blow-molded container. That is, the blow-molded lip elastically deforms inwardly in response to inwardly directed hoop stresses applied by the cap upon being pressed over the outer surface of the lip. Consequently, the cap produces a moisture tight seal over the lip to keep moisture in and wetness/humidity out. Additionally, the cap may include a hinged lid which may be manually opened or closed to access the product.

While blow molding produces a light-weight, thin-walled structure which produces highly accurate OML dimensions, the fabrication process does not control the inner mold line (IML) dimensions and, therefore, cannot employ an inwardly facing sealing surface. That is, since the IML cannot be accurately controlled, such containers cannot form a reliable seal with outwardly facing caps, i.e., caps forming a plug and seal against the IML of the container lip. Additionally, since blow-molding produces a thin-walled structure, it is often poorly-suited for packaging larger quantities of the same product or products having additional density or weight. That is, the walls tend to collapse when handling the packaged product.

Additionally, such containers and/or cap assemblies are often ill-suited for stacking and shipping prior to being filled with the consumer product. That is, since such containers favor a closed-end fill port, i.e., an end which allows the blow-molded polymer to be pneumatically blown against a mold surface, they do not typically produce a configuration with facilitates stacking. Consequently, such containers must be shipped without the benefit of nesting one container within another. As such, the cost of shipping such containers from the blow-molding facility to the packaging facility is dramatically increased. To reduce the cost of shipping, manufacturers have been faced with the unfavorable prospect of building/buying a packaging facility within a short distance of the blow molding facility. It will be appreciated that the cost of building/buying a packing facility may not be interest of the container manufacturer or visa-versa.

A need, therefore, exists for a dispensing container which is sufficiently robust for everyday use, provides a moisture-tight seal, and is volumetrically efficient to facilitate shipping and handling.

### SUMMARY OF THE DISCLOSURE

A consumer product container is provided for packaging a consumer product and comprises a top portion, a bottom portion and an intermediate body portion disposed between, and integral with, the top and bottom portions. The top portion includes an opening defining a lip having an internally-facing sealing surface configured to seal with a mating sealing surface of a closing cap. The bottom portion defines a base being substantially parallel to a plane which is normal to a longitudinal axis. The intermediate body portion circumscribes the longitudinal axis and defines an outwardly-directed draft angle relative to the longitudinal axis to facilitate stacking of multiple containers during shipment.

The above embodiments are exemplary only. Other embodiments are within the scope of the disclosed subject matter.

This brief description of the invention is intended only to provide a brief overview of subject matter disclosed herein according to one or more illustrative embodiments, and does not serve as a guide to define or limit the scope of the invention. This brief description is provided to introduce an illustrative selection of concepts in a simplified form that are further described below in the detailed description. This brief description is not intended to identify key features or essential features of the invention, nor is it intended to be used as an aid in determining the scope of the invention.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the disclosed subject matter encompasses other embodiments as well. The drawings are not necessarily to scale, emphasis generally being placed upon illustrating the features of certain embodiments of the invention. In the drawings, like numerals are used to indicate like parts throughout the various views.

FIG. 1 is a profile view of a consumer product container in accordance with an exemplary embodiment along with a closing cap configured to seal against a lip of the consumer product container such that moisture does not cross the seal interface;

FIG. 2 depicts a sectional view taken substantially through line 2-2 of FIG. 1 with the closing cap removed from a top portion of the container;

FIG. 3 is an enlarged view of a lip of the container to illustrate the configuration of a sealing surface thereof;

FIG. 4 is an enlarged view of a section through wall of an intermediate body portion of the consumer product container including first and second draft angles to facilitate stacking and shipping of the containers;

FIG. 5 is an isolated perspective view of the closing cap of the consumer product container;

FIG. 6 is a bottom view of the closing cap with a lid portion shown connected to a base portion of the closing cap by a hinged flap;

FIG. 7 illustrates a sectional view of the consumer product container with the lid of the closing cap shown in an open position and with a roll of consumer product disposed in the cavity of the container;

FIG. 8 depict an enlarged view of the sealing interface between the inwardly-facing sealing surface of the lip and a corresponding sealing surface of the closing cap;

FIG. 9 depicts a perspective view of a stack of consumer product containers prepared for transport and shipment;

FIG. 10 depicts a sectional view taken substantially through line 10-10 of FIG. 9 illustrating the import of the draft angle to facilitate stacking and shipment of multiple containers.

### DETAILED DESCRIPTION OF THE INVENTION

Various exemplary embodiments describe a consumer product container to create a moisture tight seal between a container and a closing cap. As a non-limiting example, the container includes a lip defining an inwardly-facing sealing surface configured for sealing engagement with an outwardly-facing sealing surface of a closing cap. The sealing interface may include a plurality of protrusions or ridges configured to interlock and produce a moisture-tight seal therebetween. The moisture-tight seal prevents moisture egress from a liquid-saturated consumer product or water/humidity ingress into a dry consumer product. The closing cap also ensures that the container maintains its structural integrity during consumption of the consumer product. In the exemplary embodiment, the closing cap may be removable for product refill.

The consumer product container that is also configured to facilitate packing and shipping. In the described embodiment, the consumer product containers are stackable for ease of shipping. The consumer product container is fabricated by an injection molding process wherein molten polymer is injected under heat and pressure into a mold cavity defining a container having a top portion, a bottom portion and an intermediate body portion disposed between the top and bottom portions.

The top portion of the mold cavity includes an opening defining a lip having an inwardly-facing sealing surface and a first container dimension defined by the width of the opening. As mentioned in the preceding paragraph, the inwardly-facing sealing surface is configured to engage with an outwardly-facing sealing surface of the closing cap to produce a moisture-tight seal.

The bottom portion of the mold cavity produces the base of the consumer product container which defines a second container dimension defined by the width of the base. The first diameter dimension is larger than the second diameter dimension of the consumer product container. An intermediate body portion of the mold cavity defines a longitudinal axis of the consumer product container and defines a draft angle relative to a longitudinal axis to effect the geometric change/transition between the first and second diameters. As will be discussed in greater detail hereinafter, the injection molding process produces a highly accurate and reliable sealing interface between the inwardly and outwardly-facing sealing surfaces of the lip of the consumer container and the closing cap, respectively. The draft angle relative to the longitudinal axis of the container facilitates stacking of the injection molded containers and reduces the cost of shipment associated therewith.

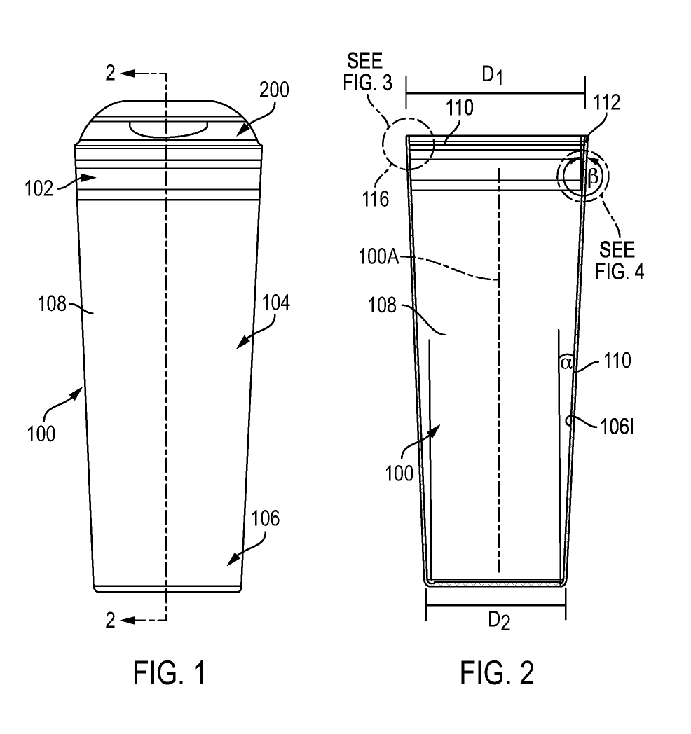

More specially and referring to FIG. 1, a first exemplary embodiment includes a consumer product container 100 enclosed by a cap 200 to produce a moisture-tight seal. The container 100 and cap 200 may be coupled and decoupled such that the container 100 and cap 200 are interchangeable with other containers 100 and caps 200 having a variety of different sizes and thicknesses.

In FIG. 2, the container 100 comprises an upper end or top portion 102, a lower end or bottom portion 104, and an intermediate body portion 106 extending between, and integrally formed with the top and bottom portions 102, 104 of the container 100. The top portion includes an opening 110 defined by a lip 112 having an internally-facing sealing surface 116 configured to seal with a mating surface 216 of the closing cap 200 (see FIG. 8). The lip 112 is disposed within, or defines a plane, substantially normal to the longitudinal axis 110A of the container 100. The bottom portion 104 defines a base of the container 100 and is substantially parallel to the plane defined by the lip 112.

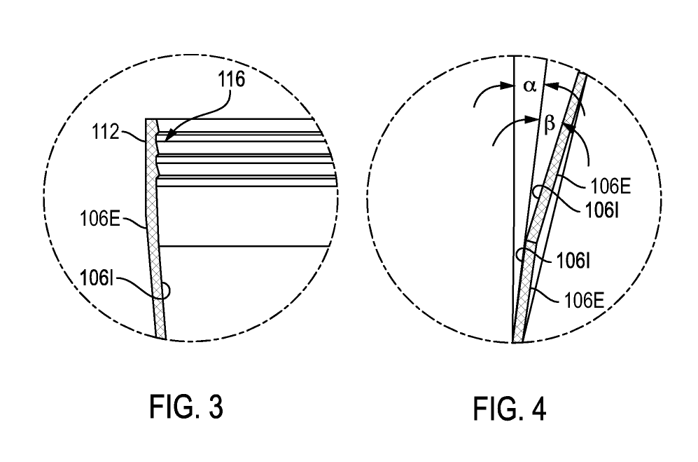

In FIGS. 2 and 3, the intermediate body portion 106 is substantially tubular, and circumscribes the longitudinal axis 100A. Furthermore, the intermediate body portion 106 defines an interior surface 1061 and an exterior surface 106E separated by a uniform thickness of about 0.028 inches. The thickness may vary within a range of between about 0.021 inches to about 0.035 inches. The interior surface 1061 defines an outwardly-directed draft angle α which is larger than about six degrees (6°). The draft angle α is the solid angle formed by the interior surface 1061 of the container 100 and a cylinder (i.e., about the longitudinal axis 100A) intersecting the interior surface 1061. Alternatively, the draft angle may simply be viewed as the angle formed by the interior surface 1061, or exterior surface 106E, and a line parallel to the longitudinal axis 100A and intersecting either of the interior or exterior surfaces 1061, 106E. In other embodiments, the draft angle α is less than an angle of about twenty degrees (20°), hence the draft angle α falls within a range of between about six degrees (6°) to about twenty degrees (20°). In yet other embodiments, and referring to FIG. 4, multiple draft angles, α and β, are formed by the interior and exterior surfaces 1061, 106E of the container. The import of the draft angle, or multiple angles, will be described in greater detail hereinafter.

Returning to FIG. 2, the container 100 may have a variety of shapes including conical, elliptical, polygonal etc., but will generally be frustoconical, or formed in the shape of an inverted frustum. The top portion 102 of the container 100 defines a diameter dimension D₁ which is larger than the diameter dimension D₂ defined by the bottom portion 104 of the container 100. In the described embodiment, the difference in diameters D1, D2, or accumulated difference, i.e., when multiple draft angles α, β are employed, effects the draft angle α of the intermediate body portion 106.

The draft angle α facilitates/enables stacking of the containers 100 during transport/shipment while accommodating ease of container separation. As mentioned in the “Background”, blow-molded containers are shipped with captured dead-air rather than by nesting multiple containers, one container into another. A draft angle α of about six degrees (6°) is employed inasmuch as angles lower than a threshold angle, e.g., an angle of about five degrees (5°), produces a friction fit between containers 100 which generally will prevent separation between the containers 100, i.e., without introducing some form of lubricant therebetween. It will be appreciated, therefore, that while the draft angle α may vary depending on the intended use of the container 100, the draft angle α should be greater than an angle α of about six degrees (6°). While draft angles below about six degrees (6°) can cause nested containers to frictionally bind, larger angles will degrade the volumetric efficiency of the product packaging. Accordingly, the draft angle α should be within a range of between about six degrees (6°) to about twenty degrees (20°).

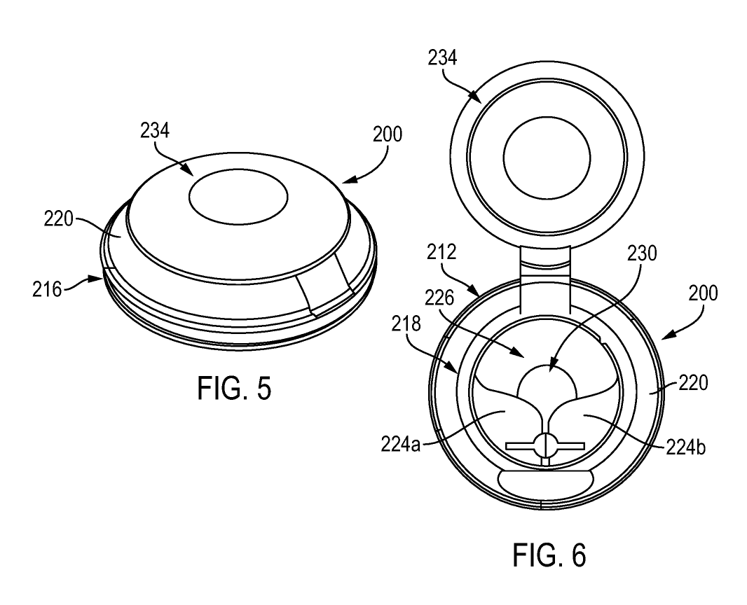

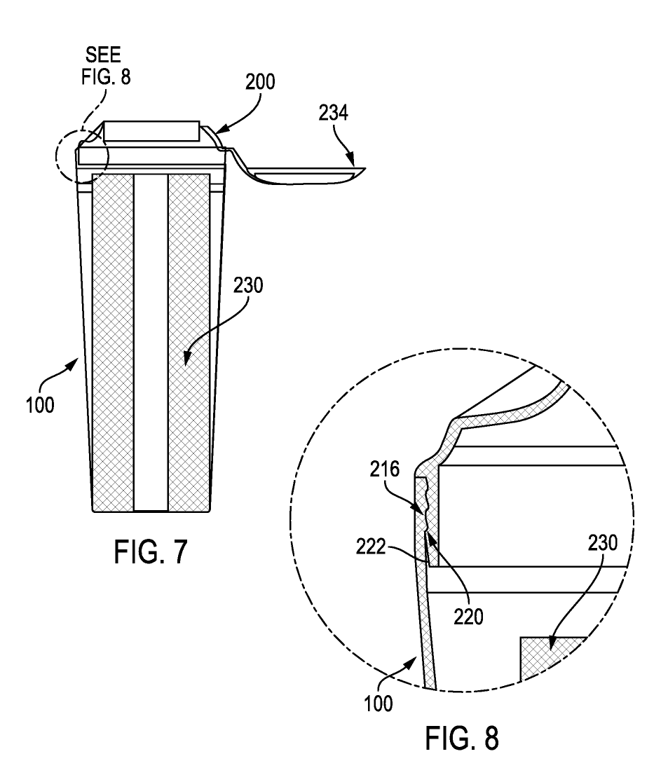

In FIGS. 3 and 5-8, the lip 112 of the container 100 includes an inwardly-facing surface 116 which mates with the outwardly-facing surface of 216 of the closing cap 200 along a mating interface 210 (see FIG. 8). The outwardly-facing surface 216 of the closing cap 200: (i) is defined by an outer ring 212 of the closing cap 200, (ii) is slightly oversized relative to the inwardly-facing surface 116 of the container lip 112 and, (iii) includes a small taper 222 to allow the outwardly-facing surface 216 to fit within, and engage, the inwardly-facing surface 116 of the container 100. The thickness of the container lip 116 defines a stiffness which is less than the overall stiffness defined by the closing cap 200. With respect to the latter, the stiffness of the closing cap 200 includes a combination of the outer ring 212, an inner ring 218 and annular upper ring 220 connecting the outer and inner rings 212 and 218. Other stiffness contributors may include the tear-drop shaped blades 224a, 224b of the inner ring 218 which defines the opening 226 for dispensing the consumer product 230 (see FIG. 7) and a hinged lid 234 connecting to, or cut from, the annular upper ring 220 of the closing cap 200.

The structurally-compliant, inwardly-facing surface 116, therefore, allows for a small degree of outward deformation in response to a tensile hoop stress applied by the structurally-stiffer closing cap 200. That is, the structurally-stiffer closing cap 200 causes the lip 112 and inwardly facing surface 116 to elastically deform outwardly in response to the insertion of the outwardly-facing surface 216 of the closing cap 200. As such, a water-tight, moisture resistant seal is formed at the sealing interface 220 between the inwardly-facing sealing surface 116 of the container 100 and the inwardly-facing sealing surface 216 of the closing cap 200. As a consequence, the sealing interface 220 prevents the ingress of water/moisture into the container 100, i.e., to protect dry consumer products contained within the container 100, and the egress of water/moisture from the container 100, i.e., to keep liquid-saturated products such as wet-napkins from drying-out.

In the described embodiment, the lip 112 of the top end portion 102 of the container 100 includes a plurality of ridges, protrusions, or peaks/troughs 120 for engaging a complimentary-shaped outer ring 216 of the closing cap 200 to augment the sealing capacity of the interface. While the mating interface 210 shows a plurality of protrusions 120, the mating interface 210 may include spikes, bumps, grooves, indents, or other shapes which are capable of interlocking with the closing cap 200 to form a moisture-tight seal. To ensure that the ridges, protrusions or peak/troughs 120 engage in a complimentary fashion, the closing cap 200 may include a radial flange or stop 236 (See FIG. 8) to determine the length of engagement by the cap 200 into the opening 216.

In the described embodiment, shown in FIG. 6, a bottom view of the closing cap 200 reveals the details of the dispensing system. More specifically, the tear-drop shaped blades 224a, 224b guide the consumer product 230 into a throat portion 238 of a dispensing system. The throat portion 238 guides the product 230 into a circular opening 240 to tear and dispense the consumer product 230 from a cylindrical roll 250. While the dispensing system depicts a tear-drop shaped aperture/opening 226 to allow the consumer to access the consumer product, it should be appreciated that an opening of nearly any shape may be employed. Additionally, the dispensing aperture 226 may have a variety of sizes and/or shapes depending upon the consumer product being dispensed.

In FIGS. 6 and 7, the lid 234 projects radially from the outer ring 216 of the closing cap 200 and pivots about a hinge axis 234A to engage an upper portion of the inner ring 216 of the closing cap 200. When the lid 206 pivots to a closed position, a rim 254 disposed on the underside of the lid 234 engages the upper portion of the inner ring 216 to close and seal the lid 234 over the inner ring 216.

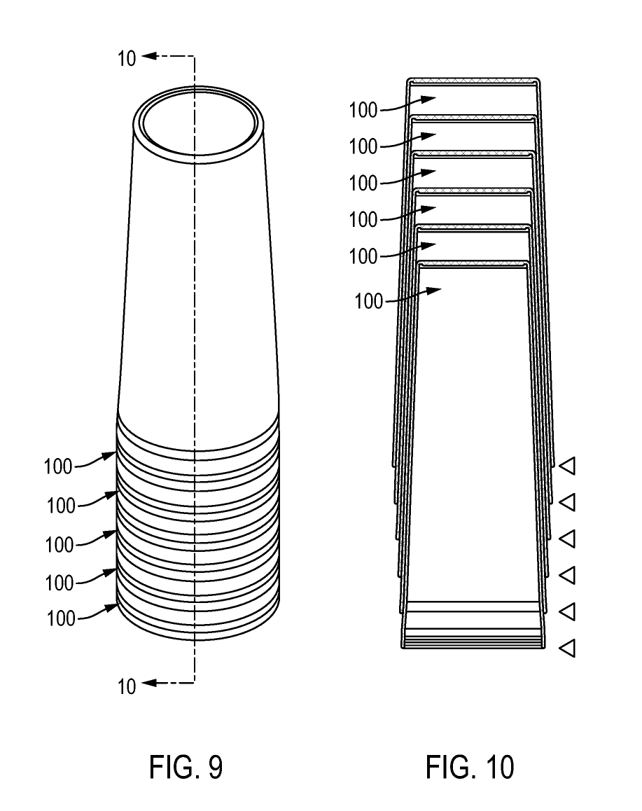

In FIGS. 4, 9 and 10, the thermoplastic forming process may fabricate a consumer product container 100 having multiple draft angles α, β. For example, in FIG. 4, the inner surface 1061 may define a first draft angle α and a second draft angle β wherein the first draft angle α facilitates stacking of the containers 100 and the second draft angle β prevents the protrusions formed along the inwardly-facing sealing surface 116 of the lip 112 from frictionally engaging an outer surface 106E of an adjacent, nested container 100. FIGS. 9 and 10 depicts a perspective and cross-section views of a nested stack 300 of consumer product containers 100 which have been prepared for transport and shipment. It will be appreciated how this configuration greatly improves shipping efficiency by reducing the amount of “air” shipped along the highways along with the fuel required for transport.

Both the container 100 and closing cap 200 are formed by an injection molding process wherein a molten polymer is injected under heat and pressure into a mold cavity defining the top, bottom and intermediate body portions as described hereinbefore. In the described embodiment, the mold cavity is injected with either a thermoplastic or thermosetting polymer. A polymer is fed into a heated barrel, mixed, and forced into the mold cavity, where it cools and hardens to the configuration of the cavity. As such, both the inner and outer mold line details of the component part to be fabricated are accurately formed/represented following removal from the thermoplastic fabrication tool. Inasmuch as thermoplastic polymers have a propensity for being more compliant following solidification, i.e., the molecules of the polymer do not cross-link in a thermosetting polymer, such polymers are better suited to fabricate the consumer product container 100. That is, since the lid 112 of the container 100 is expected to deform outwardly in response to insertion of a closing cap 200, the elastic properties of thermoplastic polymers is best suited to form the sealing interface 220.

In the described embodiment, the container 100 and the cap 200 may be made of a plastic material such as, but not limited to, polyolefins, styrenics, polypropylene, copolymer polypropylene, polystyrene, thermoplastic elastomers, thermoplastic elastomers, and other forms thereof known in the art. In additional embodiments, the container 100 and the cap 200 may be made of a flexible non-woven or woven material, such as but not limited to blow-molded, melt-blown, co-formed, air-laid, bonded-carded web materials, hydro-entangled materials, and other forms thereof known in the art. In yet additional embodiments, the container 100 and the cap 200 may be made from a plastic flexible film material, such as, but not limited to, polyethylene, polypropylene, polystyrene, copolymer polypropylene or various other forms thereof known in the art.

While the instant invention has been shown and described herein in what are conceived to be the most practical and preferred embodiments, it is recognized that departures, modifications, adaptations, variations, and alterations in the described methods and systems may be made and will be apparent to those skilled in the art of the foregoing description which does not depart from the spirit and scope of the invention which is therefore not to be limited to the details herein. For this reason, such changes are desired to be included within the scoped of the appended claims. The descriptive manner which is employed for setting forth the embodiments should be interpreted as illustrative but not limitative of the full scope of the claims which embrace any and all equivalents thereto.

### PARTS LIST

100 Container
100A Longitudinal Axis
102 Top end portion
104 Bottom end portion
106 Intermediate body portion
1061 Interior Surface
106E External Surface
α First Draft Angle
β Second Draft Angle
D₁ First Diameter Dimension
D₂ Second Diameter Dimension
110 Opening
112 Lip
116 Inwardly-facing Sealing Surface
120 Ridges, Protrusions or Peak/Troughs 120
200 Closing Cap
210 Sealing Interface
212 Outer Ring
216 Outwardly-facing Sealing Surface
218 Inner Ring
220 Annular Upper Ring
220 Mating Interface
222 Taper
224a Tear Drop Shaped Blade
224b Tear Drop Shaped Blade
226 Access/Opening for Consumer Product
230 Consumer Product
234 Lid
234A Hinge Axis
236 Radial Stop or Flange
238 Throat
240 Aperture for Dispensing Product
250 Roll for Storing Consumer Product
254 Rim
300 Nested Stack of Consumer Product

What is claimed is:

1. A container for packaging a consumer product, comprising:
a top portion, a bottom portion and an intermediate body portion disposed between, and integral with, the top and bottom portions,
the top portion having an opening defining a lip having an internally-facing sealing surface configured to seal with a mating sealing surface of a closing cap, the lip defining a plane substantially normal to a longitudinal axis;
the bottom portion defining a base for supporting the container, the base being substantially parallel to the plane defined by the lip; and
the intermediate body portion circumscribing the longitudinal axis and defining an outwardly directed draft angle (α) relative thereto, the outwardly-directed draft angle facilitating nesting of multiple containers.

2. The container of claim 1 wherein the container is fabricated by thermoplastic injection molding to form the internal and external mold lines of the container including the internally-facing sealing surface of the lip.

3. The container of claim 1 wherein the draft angle (α) is greater than about six degrees (6°).

4. The container of claim 3 wherein the draft angle (α) less than about twenty degrees (20°).

5. The container of claim 4 wherein the intermediate body portion defines at least two outwardly-directed draft angles from the base to the lip of the container, a first draft angle (α) facilitating nesting of stacked containers while a second angle (β) preventing the internally-facing sealing surface of one container from frictionally engaging an external surface of an adjacent nested-container.

6. The container of claim 1 wherein the internally-facing sealing surface comprises a plurality of annular rings which are configured to sealably engage a plurality of mating annular rings of a closing cap, the annular rings defining a plurality of nested peaks and troughs.

7. The container of claim 1 wherein the lip of the top portion defines a first diameter dimension and the base of the bottom portion defines a second diameter dimension, and wherein the first diameter dimension is greater than the second.

8. The container of claim 1 further comprising a cap having a mating sealing surface, the cap having a structural stiffness in the plane of the lip which exceeds the stiffness of the lip such that the lip deforms as the cap engages and seals the container.

9. The container of claim 8 wherein the cap includes a circular opening to facilitate access to the consumer product, and a hinged lid cooperating with the circular opening to close and open the lid.

10. A mold for producing a consumer product container, comprising:
a thermoplastic injection mold having a mold cavity defining a container having a top portion, a bottom portion and an intermediate body portion disposed between the top and bottom portions,
the top portion of the thermoplastic injection mold defining a container opening having a lip, the opening defining a plane substantially normal to a longitudinal axis, the lip of the top portion of the mold configured to produce an internally-facing sealing surface for sealing with a mating sealing surface of a closing cap;
the bottom portion of the thermoplastic injection mold defining a base for supporting the container, the base being substantially parallel to the plane defined by the opening;
the intermediate body portion of the thermoplastic injection mold defining the longitudinal axis and producing an outwardly-directed draft angle relative thereto, and
wherein the thermoplastic injection mold produces an inner mold line surface to form the internally-facing sealing surface of the lip while producing a draft angle which facilitates stacking of multiple containers.

11. The mold of claim 10 wherein the draft angle (α) is greater than about six degrees (6°).

12. The mold of claim 11 wherein the draft angle (α) less than about twenty degrees (20°).

13. The mold of claim 12 wherein the intermediate body portion defines at least two draft angles from the base to the lip of the container, a first draft angle (α) facilitating nesting of stacked containers while a second draft angle (β) prevents the internally-facing sealing surface of one container from frictionally engaging an external surface of an adjacent nested container.

14. The mold of claim 10 wherein the internally-facing sealing surface comprises a plurality of annular rings which are configured to sealably engage a plurality of mating annular rings of a closing cap, the annular rings defining a plurality of nested peaks and troughs.

15. The mold of claim 10 wherein the lip of the thermoplastic injection mold defines a first diameter dimension and the base of the thermoplastic injection mold defines a second diameter dimension, and wherein the first diameter dimension is greater than the second diameter dimension.
